(19) United States
(12) Patent Application Publication
(10) Pub. No.: US 2014/0075281 A1
(43) Pub. Date: Mar. 13, 2014

(54) SYSTEMS AND METHODS FOR ANNOTATING DIGITAL DOCUMENTS

(71) Applicant: David Rubin, Menlo Park, CA (US)

(72) Inventor: David Rubin, Menlo Park, CA (US)

(21) Appl. No.: 14/027,156

(22) Filed: Sep. 13, 2013

Related U.S. Application Data
(60) Provisional application No. 61/743,875, filed on Sep. 13, 2012.

(51) Int. Cl. G06F 17/24

(52) U.S. Cl. CPC G06F 17/241
USPC 715/230

(57) ABSTRACT

Embodiments of systems and methods are disclosed providing for annotation of digital documents, such as html and xml documents. In various embodiments, virtual note-paper can be generated with a background-image that is a facsimile of a reviewer-selected portion of a digital document. Annotations can be made on the facsimile and attached to the digital document in a location chosen by the reviewer. The annotations can be typed (e.g., via keyboard input device) or drawn (e.g., via mouse, finger or stylus) on the virtual note-paper.

### CROSS-REFERENCE TO RELATED APPLICATION

This application claims a priority benefit from U.S. Provisional Patent Application. No. 61/743,875, filed Sep. 13, 2012, which is incorporated herein by reference in its entirety.

### FIELD

The present teachings relate to the field of digital documents, and computer-implemented systems and methods for annotating digital documents.

### BACKGROUND

While approaches exist for reviewer comments for digital documents, there is still an unmet need to provide a simple and convenient markup mechanism. Further, in various circumstances, there can be advantages to be realized from a markup mechanism that approximates the way a copy-editor comments on a physical printed document with a pen or pencil.

### SUMMARY

Various aspects of the present teachings provide systems and methods providing for annotation of digital documents, such as html and xml documents. In various embodiments, virtual note-paper can be generated with a background-image that comprises a facsimile of a reviewer-selected portion of a digital document. Annotations can be made on the facsimile and attached to the digital document in a location chosen by the reviewer. The annotations can be typed (e.g., via keyboard input device) or drawn (e.g., via mouse, finger, trackball, touchpad, stylus, and the like) on the virtual note-paper.

In various aspects, the present teachings provide methods for annotating digital documents. According to various embodiments, methods of the present teachings can comprise, for example: (i) providing an original digital document; (ii) selecting a first portion of the original digital document to be annotated, thereby creating a selected original first portion; (iii) transcribing the selected original first portion to a format permitting annotation, thereby creating a converted first portion, while preserving the selected original first portion; (iv) annotating the transcribed (converted) first portion, thereby creating an annotated first portion; (v) associating the annotated first portion with a location of the selected original first portion, thereby creating an associated annotated first portion; (vi) persistently storing the associated annotated first portion, thereby creating a stored associated annotated first portion; (vii) retrieving the stored associated annotated first portion, thereby creating a retrieved associated annotated first portion; and, (viii) displaying the retrieved associated annotated first portion adjacent the selected original first portion or a previously retrieved associated annotated first portion, if any.

According to various embodiments, steps (ii) through (viii) can be repeated. In various embodiments, the original digital document comprises an html or xml document. In various embodiments, the format permitting annotation comprises a raster graphics image format, such as GIF, TIFF, JPEG, BIFF, bmp, PICT, Clear, FITS, IFF, NFF, OFF, PCX, PNG, TGA, XBM, and the like.

Various aspects of the present teachings relate to computer-implemented methods for annotating digital documents. In an exemplary embodiment, such a method according to the present teachings can comprise, for example: (i) transmitting over a network, such as a PAN, LAN, WAN, and/or the Internet, instructions (e.g., software code), executable at a remote computing device (e.g., a PC, smart phone, laptop, tablet, and the like), providing functionality for annotating a digital document (e.g., an html or xml document), including encoding into raster graphics image format a user-selected portion of the digital document; (ii) receiving from the remote computing device, over the network, a raster graphics image comprising a facsimile of the user-selected portion of the digital document and one or more user annotations; (iii) associating the annotated image with a location of the user-selected portion within the digital document; (iv) placing the annotated image in persistent storage, such as a database; (v) receiving from the remote computing device, over the network, a request for the stored annotated image; and (vi) transmitting to the remote computing device over the network, the retrieved annotated image; whereby, when the user-selected portion of the digital document is displayed at the remote computing device, the retrieved annotated facsimile can be displayed proximate thereto.

In various embodiments, the method steps are carried out by one or more server computing systems. In some embodiments, the method steps are carried out by no more than one server computing system.

According to various embodiments, the method can further comprise assigning a unique identifier to the annotated image. In some embodiments, the method also comprises transmitting the identifier over the network to the remote computing device.

In various embodiments, the method can further comprise transmitting instructions for placement of the annotated image within the digital document.

In a variety of embodiments, a computer-implemented method for annotating digital documents can comprise, for example: (i) transmitting over a network instructions, executable at a remote computing device, providing functionality for annotating a digital document, including encoding into raster graphics image format a user-selected portion of the digital document; (ii) receiving from the remote computing device, over the network, an image comprising a facsimile of the user-selected portion of the digital document; (iii) assigning a unique identifier to the image; (iv) transmitting the identifier over the network to the remote computing device; (v) transmitting over the network to the remote computing device the image for annotation; (vi) receiving the image, once annotated, from the remote computing device; (vii) associating the annotated image with the location of the user-selected portion within the digital document; (viii) placing the annotated image in persistent storage; (ix) retrieving the annotated image from persistent storage; and, (x) transmitting over the network to the remote computing apparatus the retrieved annotated image with instructions for placement in the digital document at or in the vicinity of its associated location; whereby, when the user-selected portion of the digital document is displayed at the remote computing device, the retrieved annotated facsimile is displayed proximate thereto.

In various embodiments, the method steps are carried out by one or more server computing systems. In some embodiments, the method steps are carried out by no more than one server computing system.

Various aspects of the present teachings relate to methods for annotating digital documents using network-capable computing devices. In various embodiments, such a method can comprise, for example: (i) providing a digital document, such as an html or xml document; (ii) transmitting a request over a network, such as a PAN, LAN, WAN, and/or the Internet, to a server for instructions, executable at the computing device, providing functionality for annotating the digital document, including transcribing into raster graphics image format a selected portion of the digital document; (iii) receiving the instructions from the server; (iv) selecting a portion of the digital document for annotation; (v) transcribing the selected portion of the digital document to a raster graphics image; (vi) annotating the image; (vii) displaying the annotated image proximate the selected portion of the digital document.

In various embodiments, the method steps are carried out by a client computing device, such as a PC, a laptop, a tablet, a smart phone, and the like.

In various embodiments, the annotating step is carried out freehand. For example, the annotating step can be carried out, according to various embodiments, using a touchpad, trackball, mouse, finger, stylus, and the like.

According to various embodiments, the annotating step can include creating one or more geometric shape annotations (e.g., a square, a rectangle, a circle, an oval, a triangle, etc.). In a variety of embodiments, the one or more geometric shape annotations are created as bitmapped images, which are superimposed on the raster graphics image.

In various embodiments, the annotating step can include creating one or more styled text annotations.

According to a variety of embodiments, a method for annotating a digital document can comprise, for example: (i) providing a digital document, such as an html or xml document; (ii) executing using a processor instructions in the nature of software code providing functionality for annotating the digital document, including transcribing into raster graphics image format a selected portion of the digital document; (iii) selecting a portion of the digital document for annotation; (iv) transcribing the selected portion of the digital document to a raster graphics image; (v) annotating the image; and, (vi) displaying the annotated image proximate the selected portion of the digital document.

In various embodiments, the method steps are carried out by a client computing device, such as a PC, a laptop, a tablet, a smart phone, and the like.

According to various embodiments, the instructions are received from one or more server computing systems.

In various embodiments, the digital document comprises an html or xml document.

According to various embodiments, the method can further comprise analyzing the document object model (DOM) elements and attributes related to the selection from step (iii).

In a variety of embodiments, a method for annotating a digital document using a network-capable computing device can comprise, for example: (i) providing a digital document; (ii) transmitting a request over a network to a server for instructions, executable at the computing device, providing functionality for annotating the digital document, including transcribing into raster graphics image format a selected portion of the digital document; (iii) receiving the instructions from the server; (iv) selecting a portion of the digital document for annotation; (v) transcribing the selected portion of the digital document to a raster graphics image; (vi) transmitting the image over the network to the server; (vii) receiving over the network from the server a unique identifier for the image; (viii) receiving over the network from the server the image for annotation; (ix) annotating the image; (x) transmitting the annotated image to the server; (xi) receiving the annotated image from the server, with the annotated image associated with the selected portion of the digital document; and, (xii) displaying the annotated image proximate the selected portion of the digital document.

Various aspects of the present teachings relate to non-transitory or physical, computer-readable storage mediums containing program code for, when executed by a computing system, performing methods for annotating digital documents. In an exemplary embodiment, such a method can comprise, for example: (i) transmitting over a network instructions, executable at a remote computing device, providing functionality for annotating a digital document, including encoding into raster graphics image format a user-selected portion of the digital document; (ii) receiving from the remote computing device, over the network, a raster graphics image comprising a facsimile of the user-selected portion of the digital document and one or more user annotations; (iii) associating the annotated image with a location of the user-selected portion within the digital document; (iv) placing the annotated image in persistent storage; (v) receiving from the remote computing device, over the network, a request for the stored annotated image; and (vi) transmitting to the remote computing device over the network, the retrieved annotated image.

In a variety of embodiments, the method can further comprise assigning a unique identifier to the annotated image.

Various aspects of the present teachings relate to computing systems for annotation of digital documents. In an exemplary embodiment, such a system can comprise, for example: a network interface for communication over a network; a memory comprising at least one software program comprising instructions, distributable over the network to one or more remote locations, providing functionality upon execution by a processor for annotating a digital document, including encoding into raster graphics image format one or more user-selected portions of the digital document; an input for receiving, from the one or more remote locations over the network, a raster graphics image comprising a facsimile of a user-selected portion of a digital document and one or more user annotations; an output for transmitting to the one or more remote locations over the network (a) the received annotated image, and (b) the instructions; a persistent storage device for storage and retrieval of the received annotated image; and, an associator (or association) component for associating the annotated image with a location of the user-selected portion within the digital document.

In various embodiments, the memory further comprises at least one software program comprising instructions, distributable over the network to the one or more remote locations, providing functionality upon execution by a processor for placement of the annotated image at or proximate its associated location.

According to some embodiments, the system can further comprise an identifier (or identification) component for assigning a unique code to the received annotated image.

These and other features and advantages of the present teachings will become clear from the following description.

### BRIEF DESCRIPTION OF THE DRAWINGS

The structure and manner of operation of the present teachings, together with the further objects and advantages thereof, may best be understood by reference to the following description taken in conjunction with the accompanying drawings, in which:

FIG. 1 is a diagram showing an enterprise web application architecture for the annotation of digital documents in accordance with various embodiments of the present teachings;

FIGS. 2A-2G provide the flow of a process for the annotation of digital documents, as contemplated by various embodiments of the present teachings. Individually, FIG. 2A depicts the initial context; FIG. 2B depicts document segment selection; FIG. 2C depicts generation of selection reconstruction data; FIG. 2D depicts reconstruction of selection on draw-enabled object; FIG. 2E depicts collection of user annotation on reconstructed selection; FIG. 2F depicts saving of annotated reconstruction with placement meta-data; and, FIG. 2G depicts retrieving and displaying annotation; and,

FIGS. 3A-C depict screen captures of a user interface on a computing device configured for annotating digital documents, in accordance with various embodiments of the present teachings.

### DESCRIPTION

Reference will now be made to various embodiments. While the present teachings will be described in conjunction with various embodiments, it will be understood that they are not intended to limit the present teachings to those embodiments. On the contrary, the present teachings are intended to cover various alternatives, modifications, and equivalents, as will be appreciated by those of skill in the art.

Various aspects of the present teachings provide computer-implemented systems and methods providing for annotation of digital documents, such as html or xml documents. Generally, in accordance with various embodiments, virtual note-paper can be generated with a background-image that is a facsimile of a reviewer-selected portion of a digital document. Annotations can be made on the facsimile and attached to the digital document in a location chosen by the reviewer. The annotations can be typed (e.g., via keyboard input device) or drawn (e.g., via mouse, trackball, touchpad, finger, stylus, and the like) on the virtual note-paper.

A user can select portions of a text document for annotation and, according to various embodiments, the systems and methods of the present teachings can: (1) convert them to a format providing for annotations, (2) provide mechanisms to create these annotations, (3) persist these as retrievable document annotations, and (4) re-render them along with the original document as needed by the user.

According to various embodiments, an exemplary method of the present teachings can comprise, for example: (i) providing an original digital document, such as an html or xml document; (ii) selecting a first portion of the original digital document to be annotated; (iii) transcribing (copying or converting) the selected original first portion to a format permitting annotation, such as a raster graphics image format (e.g., GIF, TIFF, JPEG, BIFF, bmp, Clear, FITS, IFF, NFF, OFF, PCX, PNG, TGA, XBM, and the like), while preserving the format of the selected original first portion; (iv) annotating the transcribed first portion; (v) associating the annotated first portion with a location of the selected original first portion; (vi) persistently storing the associated annotated first portion; (vii) retrieving the stored associated annotated first portion; (viii) displaying the retrieved associated annotated first portion adjacent the selected original first portion or a previously retrieved associated annotated first portion, if any. According to various embodiments, steps (ii) through (viii) can be repeated, as desired.

In various embodiments, aspects of the present teachings can be implemented employing a computing environment such a described in U.S. Pat. No. 7,259,753; incorporated herein by reference.

An exemplary embodiment of a software application of the present teachings is described next.

Before describing functional capabilities of the exemplary embodiment of the software application, several assumptions are set forth. One, there is an html document (i.e., digital document) author and an html document commenter (these two roles could be performed by the same person or different people). Next, there is a software application which provides at least the functionality described herein installed on a computing device (e.g., PC, tablet, smart phone, laptop, etc.) which gives the commenter access to the document object model (DOM) that represents the digital document to be commented on. Finally, the application utilizes a browser interface which supports the HTML5-compliant ‘canvas’ or a similar object that can contain textual, vector graphical and rasterized data-objects.

Next, several functional capabilities of the exemplary embodiment of the software application are set forth.

The exemplary embodiment of the software application can parse an arbitrary portion of the HTML document and re-render its elements in an HTML5 canvas (or canvas-like object provided by future extensions to the HTML standards) using DOM-retrievable style-sheet (CSS, or Cascading Style Sheets) attributes to faithfully represent the original element. For example, for a text element (e.g. a text area or content-editable div) the parser-renderer can re-create the element with the correct font-size, font-style, text container dimensions, and container attributes (e.g. positioning, padding, text-color, background-color, background-image, etc.). Elements that are parsed and re-rendered can include all standard HTML elements.

The exemplary embodiment of the software application can permit the commenter to annotate (draw over) the re-rendered HTML elements by providing one or more drawing modes which add annotation data to the canvas, including, in various embodiments, freehand drawing by moving a cursor over the canvas with the cursor position controlled by a finger or stylus on a touch-screen or a mouse on a standard PC, smoothed drawing utilizing a freehand input and smoothing algorithms, overlay of text using a physical or simulated keyboard, and overlay of geometric shapes (lines, rectangles, circles, arrows, etc.) using freehand input and shape recognition, and rasterized objects such as images.

The exemplary embodiment of the software application can retain, via persistent storage (e.g., a database) these annotated canvas-based replications of portions of the original HTML document as images—which are composites of all canvas elements, as serialized canvasses, or as lists of elements and parameters required to faithfully recreate the canvasses, which are stored with meta-data specifying which part of the original HTML document each annotation is associated with.

The exemplary embodiment of the software application can re-render the original document for the author or the commentator to review and can retrieve, reconstruct and display the saved annotations in a manner permitting the user to see both the original document and the annotations (e.g. in a superimposed div or pop-up div that is opened/closed when the user clicks on a marginal or in-text marker).

According to various embodiments of the present teachings, a user who wishes to attach a comment (annotation) to a digital document can specify a snippet of the document which s(he) wishes to have copied (converted or transcribed) and superimposed on virtual note paper as a background note image, so that annotations can be made on the note rather than directly on the digital document. This can be useful, for example, in circumstances where the commenter wants their annotation preserved along with the state of the digital document before the author (or another user) changes the document, e.g., in response to the annotation. In various embodiments, it can also facilitate types of edits which can be more readily grasped when they are drawn (like an editor's marks) instead of attached as typed comments or incorporated as suggested revisions in the form of edits which change the text but can be accepted or rejected by the author.

According to various embodiments, methods and systems can be employed that avoid security restrictions regarding construction of a rasterized copy of a document snippet. An exemplary embodiment contemplated herein is a web-application software implementation which supports both the document creation and the comments, with the software instructions that control the application being served from a single server governing all aspects of the software session where a document is served and comments are affixed. This enables the application to have access to the browser's document object model (DOM) that underlies its screen rendering of the document and permits the user leaving a comment to specify a snippet of a document by selecting it with a GUI tool (e.g. a mouse) with sufficient precision that a software routine can be invoked to determine what HTML elements in the DOM correspond to the selection. The DOM elements can then be parsed and re-rendered into an HTML5 canvas using the information about the set of HTML elements which define the software snippet and the “in-line” or “style-sheet” styles that give the elements their specific appearance (type style, type size, type color, font, table specifications, image specifications, etc.). Once the selected elements have been rendered into a canvas, the canvas can be serialized and transmitted to a server which can apply conversion routines to generate and return a rasterized representation (e.g. a jpeg, png or other raster graphics image) so that a virtual note paper can be displayed for the commenter to draw and/or type upon. It should be appreciated that conversion could be accomplished on a client PC. Regarding embodiments where the device being used for review and comment is a tablet with a stylus or finger touch-screen interface, for example, drawing on the notes with document-snippet backgrounds described here can be quite efficient and intuitive and can greatly enhance ease-of-use in leaving annotations.

In accordance with various embodiments of the present teachings, implementation as a web-application can employ a client computing device, at least one server computing device, and a network system (e.g. the Internet or World Wide Web) to provide protocols for interconnection of client and server(s).

In various embodiments, the client computing device can comprise network communications hardware capability (e.g. a network card) and a graphical user interface (GUI) with text entry capability and optionally a pointing/drawing input device such as a mouse or touch-sensitive screen.

In various embodiments, the server computing device(s) can comprise network communications hardware capability (such as a network card) and the capability to respond to client requests for information via a communications protocol (e.g. http) involving the dynamic creation of responses to client queries (e.g. http responses) drawing upon data stored in a persistent storage system (e.g., a database) implemented on the same server or another server.

In various embodiments, the network system, which in one exemplary configuration is provided via the world-wide web, can permit access and communication by multiple client devices.

In various embodiments, the system of client devices, server devices and interconnecting communications system can be scalable—for example, on the “server-side” via distribution of response task across as many servers as are necessary to respond to client information requests without significant delays.

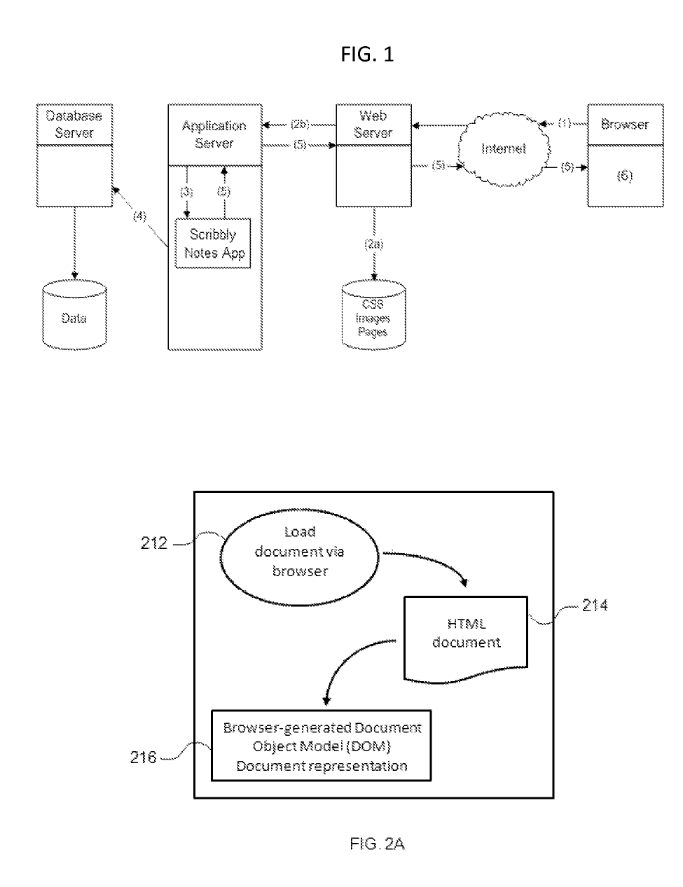

Referring now to FIG. 1, a diagram is shown of an exemplary embodiment of an enterprise web application architecture of the type suitable to implement various embodiments of the web application of the present teachings. Noting that the numerals immediately below correspond to the reference numerals in FIG. 1, the flow of control in the architecture can comprise:
(1) The browser sends a request for a resource to the web server.
(2) The web server responds to the request.
   a) Static resources such as images, CSS and static web pages are read from disk and returned directly to the browser.
   b) Requests for dynamic resources such as user-specific documents or document components (virtual note paper) are forwarded to an application server.
(3) The application server passes the request to the web application of the present teachings.
(4) The web application constructs a response using data from the database server when appropriate.
(5) The response is passed back up the chain to the browser.
(6) The browser displays the response.

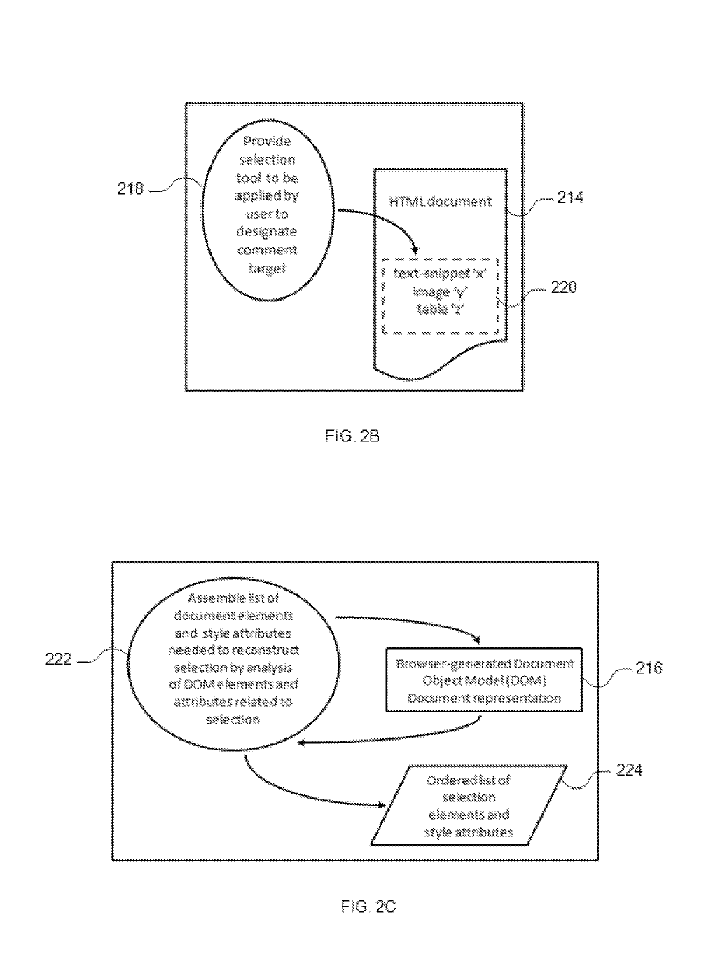

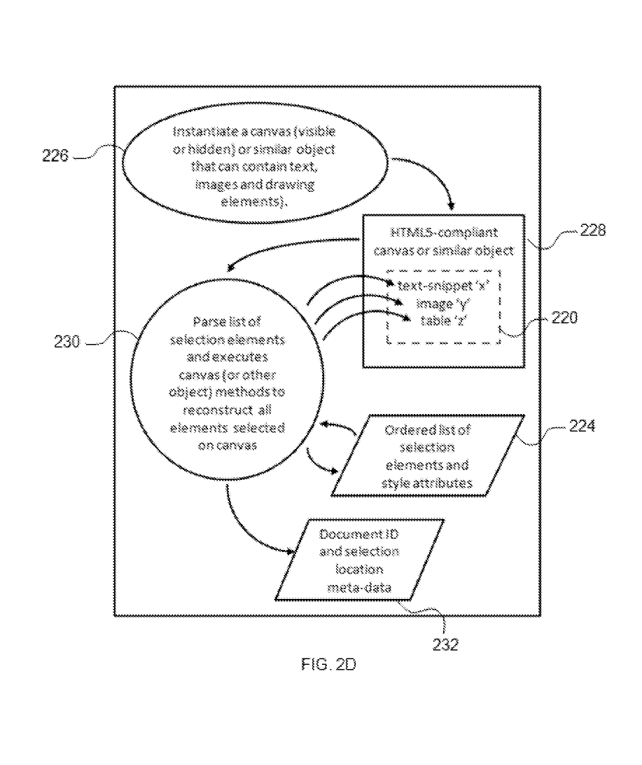

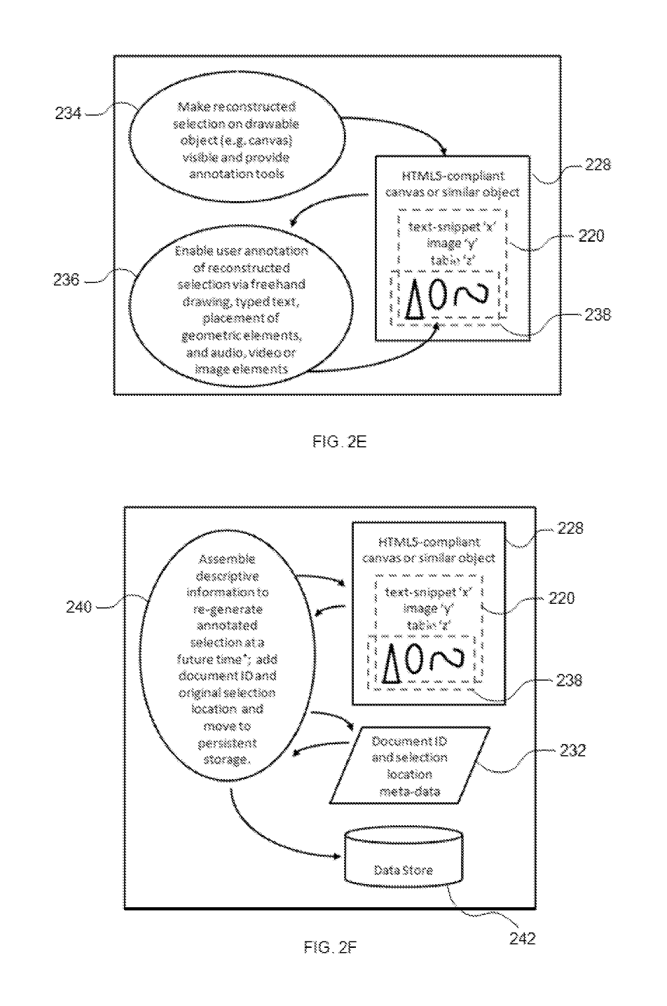

FIGS. 2A-2G provide the flow of the annotation process, as contemplated by various embodiments of the present teachings. As shown in FIG. 2A, in step 212, an html document, designated by the reference numeral 214, is loaded via a web browser, and then at step 216 a browser-generated document object model (DOM) representation is generated. As shown in FIG. 2B, in step 218, a selection tool is provided to be applied by a user to designate a comment target on the document, as represented by the broken-line rectangle 220. As shown in FIG. 2C, in step 222, a list is assembled of document elements and style attributes for reconstructing the selection by analysis of the DOM elements and attributes related to the selection. The result is an ordered list of selection elements and style attributes, designated at 224. As shown in FIG. 2D, in step 226, a canvas (visible or hidden) or similar object, 228, that can contain text, images and drawing elements is instantiated. In step 230, the list of selection elements is parsed, and canvas (or other object) methods are executed to reconstruct all elements selected on the canvas. In step 232, a document ID and selection location meta-data are provided. As shown in FIG. 2E, in step 234, the reconstructed selection on the drawable object (e.g., canvas) is made visible and annotation tools are provided. In step 236, user annotation of reconstructed selection via freehand drawing, typed text, placement of geometric elements (such as at 238), and audio, video or image elements is enabled. As shown in FIG. 2F, in step 240, descriptive information is assembled to re-generate the annotated selection at a future time. (Note, annotation can be converted on server side to an image or construction of the annotation can be done on the client side, immediately or at a future time.) The document ID and original selection location 232 are added and it is moved to persistent storage, as at 242. As shown in FIG. 2G, in step 244, the document ID is used to determine which annotations to retrieve and to retrieve annotation placement data. Annotations can be positioned as open “notes” over the relevant document sections or they can be represented by marginal or in-text icons and opened when icons receive user “open” events.

In an exemplary embodiment, the HTML representing a portion of a browser-rendered document is transformed on a user's PC to a digital image and transmitted via http to a server where it is (a) assigned a unique identifier, and (b) stored as an image in a manner enabling its retrieval by referencing it using the unique identifier. The unique identifier is returned to the remote computing device so that the image can subsequently be retrieved.

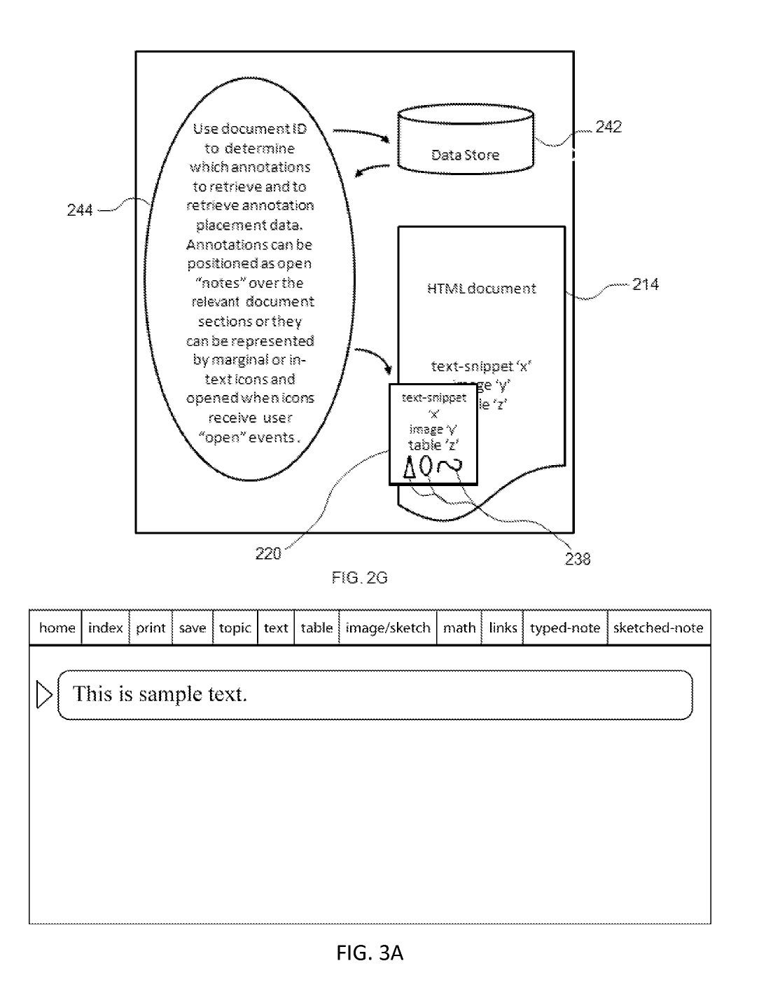

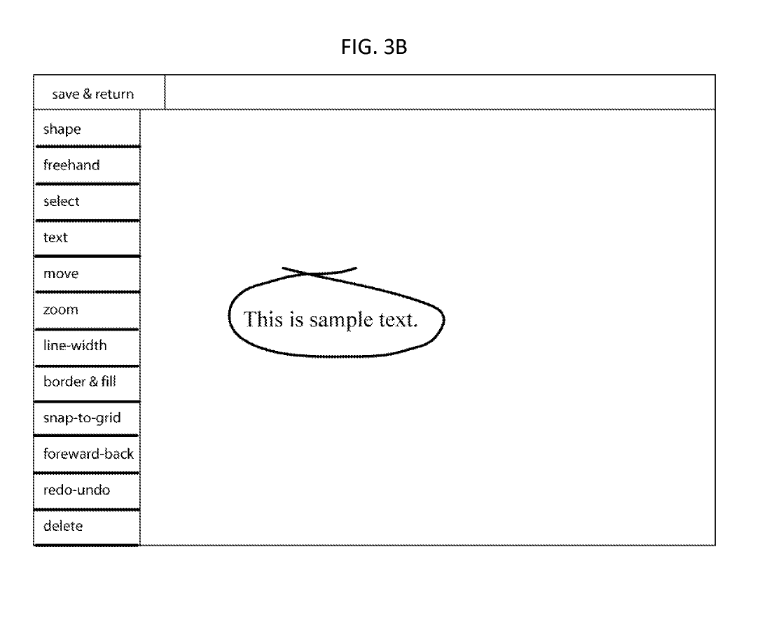

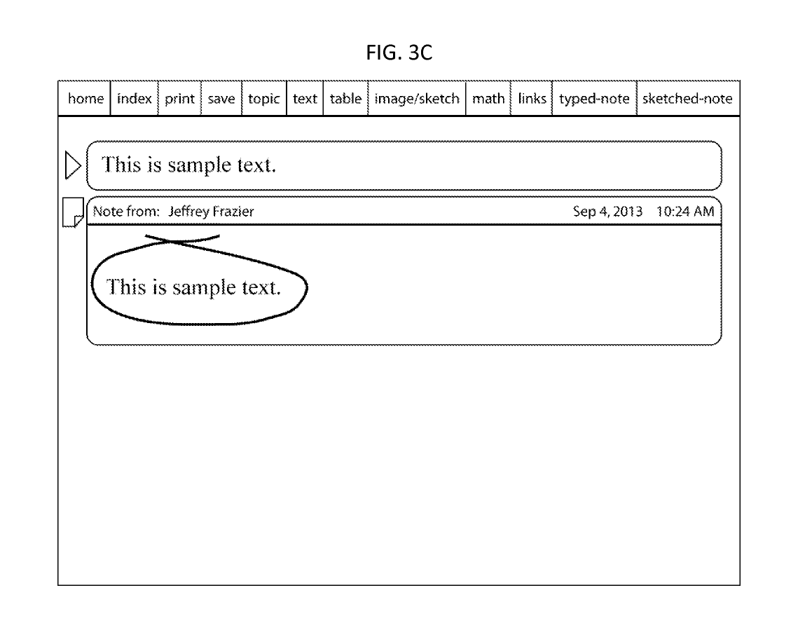

FIGS. 3A-C depict screen captures of a (graphical) user interface (UI or GUI) on a screen, such as a CRT, LCD, LED, or OLED screen, of a computing device configured for annotating digital documents in accordance with various embodiments of the present teachings.

FIG. 3A shows a browser window as shown on a screen. A plurality of links and functions are provided horizontally along a line across the upper region of the browser window. Below those, an elongate text box can be seen containing a line of sample text. To generate such text, a user can select the “text” tab, or icon, along the top of the browser window. This action or event causes a text box to appear in the space below. A curser can be placed in the text box and the user can type any desired text. In this way, a digital document can be created.

When the “sketched-note” tab, or icon, is selected along the top of the browser window of FIG. 3A, the user interface of FIG. 3B appears in a browser window. Notably, an image of the typed text from FIG. 3A can be seen on the screen of FIG. 3B. Unlike the typed text of FIG. 3A, however, the image of FIG. 3B can be annotated with a set of annotation tools provided. Any desired set of annotation tools can be employed. In the depicted embodiment, buttons for such a set of tools are provided vertically along a line down the left-hand side of the browser window. Among the tools, included are a freehand drawing tool, a text tool, a shape tool, a selection tool, a line-width tool, etc. As can be seen in FIG. 3B, the sample text is circumscribed by a black line, which serves herein as an exemplary annotation. Such a line can be drawn using, for example, the freehand tool and a mouse. In the upper left-hand portion of the browser window is a “save & return” button, which permits a user to save their work (i.e., an annotated image), and return to a window having the digital document.

FIG. 3C shows the browser window of FIG. 3A, but now having an elongate virtual note inserted immediately beneath the text box containing the sample text. Thus, simultaneous viewing is permitted of the original digital text, as well as the annotated virtual note comprising an image of the text. To the left of the virtual note, a document-shaped icon can be seen. Upon clicking on this icon, the virtual note can be collapsed or, if it were collapsed, it could be expanded. Multiple virtual notes can be inserted beneath the original digital text. When the virtual notes are maximized, the plural virtual notes can stack, one over the other, underneath the original digital text with the most recent annotation closest thereto.

Further aspects of the present teachings relate to a web application comprising a document management system (DMS) providing for user roles, for example, as teacher (or group leader) and student (or group member). In accordance with various embodiments, the DMS is designed as a single comprehensive system providing for functionality comprising, for example:
i) A teacher (or group leader) creates an initial document requesting a within-document response by a student (or group member), such as a worksheet to be completed for homework.
ii) The teacher (or group leader) distributes the assignment to one or more students (group members) using functions provided by the application to clone documents and assign new ownership to each of the clones corresponding to each student or group member selected by the teacher or group leader to receive a copy.
iii) Each recipient responds by modifying their copy of the distributed document by adding (or, in some embodiments, selectively removing) text or images, or sketched material, or integrating rich media such as audio notes or inserted video.
iv) The teacher (or group leader) retrieves and evaluates the modifications made by each recipient via access to these cloned, now modified, documents provided through the application.
v) The teacher (or group leader) comments on selected modifications by each recipient using virtual notes (either typed or sketched) provided by the application to communicate corrective or reinforcing information to the recipient (which could be, for example, a grade indicating the quality of the recipient's response).
vi) In another optional configuration the teacher (group leader) can selectively enable student (group member) access of other student's (group member's) documents so that students can assume the role of evaluators and corrective or reinforcing feedback providers.
vii) The recipient's access the now teacher-commented (group leader-commented) document to review the corrective or reinforcing feedback and either retain that information for use in subsequent tasks requiring the application of similar skills or knowledge, or modify the document further to iterate another time through the response and critique cycle aiming to further refine skills and knowledge or to improve a grade assigned by the teacher (group-leader).
viii) According to various embodiments, this iterative process of task definition (in the form of initial document design by the teacher or group leader), distribution to recipients, response by recipients, collection and critiquing by the teacher or group leader, results in the accumulation of a database of student (group member) work representing an accumulating portfolio that can be reviewed by the individuals participating in the process (assuming they have permission to access the content), or those outside the process (who have access permission) who may want to evaluate the skills and knowledge or rate of progress in developing skills and knowledge of one or more students (group members).

In various embodiments, the entire system providing for document creation, modification, retrieval, and critique resulting in persistently stored portfolios of individual's responses to tasks requiring expressive communication is in toto designed to support a process of continuing skill/knowledge improvement in a social context defined by teachers or group managers, and students or group members sharing the objective of skill and knowledge development in one or more domains.

Various aspects of the present teachings relate to a sketch component of an application as contemplated herein. In accordance with various embodiments, one or more of the following features comprise an exemplary approach to supporting sketching in, for example, a PC or tablet-based system.

i) According to various embodiments, a sketch component according to the present teachings can provide for the interconnection of shapes (e.g., rectangles, triangles, circles, ellipses, diamonds) by lines (e.g., horizontal, vertical, oblique) that are plain or arrow-headed (single arrow-heads or double arrow heads) whereby once connections are made the connections are maintained (e.g., two rectangles connected by a line will persist the connections as either rectangle is moved by causing the line to lengthen and/or the angle of the line to change). This persistence of interconnections is maintained across arbitrarily complex sketches comprised of interconnecting shapes and lines. It is also maintained across editing operations (e.g., changing line or shape properties such as line thickness, shape border thickness, line color, and shape fill color).

ii) In various embodiments, in an interconnected network of lines and shapes, the sketch component provides for the disconnection of a line from a shape by detecting that (a) a virtual-attachment of a mouse, stylus, or finger-controlled cursor to a line has occurred, and (b) that after the virtual attachment has occurred a virtual “jerk” on the line has occurred detected algorithmically by using the rate of change of cursor location compared to a threshold rate of change metric to deduce that the user is intentionally jerking on the line to detach it from a connected shape. Similarly, in various embodiments, a shape can be selected by a user instead of a line, and if the shape is connected to a line and virtually jerked, the shape can be disconnected from the line using the same virtual attachment detection algorithm and virtual jerk detection algorithm that were used to determine that the line should be separated from the shape.

iii) Various embodiments of the sketch component of the present teachings provide for the duplication of a single sketched element (a line, a shape, an image, a string of alpha-numeric characters) or a composite of selected elements by detecting an icon click (indicating the user's desire to duplicate elements) as a duplication-triggering event, immediately thereafter placing the duplicate(s) in an active state during which it is temporarily managed as a single composite element until the point that it is released from its active state at which point the individual elements comprising it are added to the sketches individual element list, each with the properties it inherited from the parent element from which the copy was made.

iv) According to various embodiments, a sketch data structure is provided which references each sketch component (e.g., a line, a shape, a text string, an image) as a member of the sketch which has attributes including x, y location, element type, and other attributes that may be element-specific. Various embodiments contemplate an attribute that is a movable/unmovable attribute which can optionally be conditioned on a “author” attribute so that in a sketch created by a teacher (for example) a set of virtual containers could be drawn by a teacher which are set by the teacher to be unmovable, and a set of shapes could be drawn by a teacher and set to movable so that a student learning to sort shapes would be able to access the sketch and move the shapes to the containers they belong with, but would not be able to move the containers. The teacher would be able to move the shapes or the containers because the application providing the sketch user interface would recognize whether the teacher or the student was “logged in” to the application and enable the appropriate rule to be applied to the sketch elements that had movable or unmovable attributes assigned.

v) In various embodiments, the sketch component of the present teachings makes shapes adjustable (e.g., stretching a rectangle lengthwise by mouse-down clicking when the cursor is sufficiently close to a rectangle side and then mouse-dragging with the mouse button still depressed). To enable this feature, the mouse cursor location is tracked within the sketch UI and the cursor shape is automatically changed so that the user can determine by watching the cursor when they have positioned the cursor sufficiently close to a shape side or corner that they are in a click-and-drag zone for that shape.

### EXAMPLES

The following examples are merely illustrative and are not intended in any manner to limit the scope of the present teachings or of the claims directed thereto.

### Example 1

### Use Case Scenario—Writing Instruction or Copy Editing

Teachers providing corrective feedback to students often find it most efficient to make traditional editorial markings on submitted documents. If these are digital documents, teachers frequently feel they need to print them and then write on them with pen or pencil. When they do this, students consider the comments as they make modifications to their saved word processor versions, and resubmit digitally. But in many teaching contexts there is strong interest in keeping all corrective feedback in digital form, so it can be preserved and reviewed later by the teacher who may want to gauge student progress at grading time. But incorporating traditional editing feedback in a Microsoft Word document, or in a Google document requires either leaving typed notes, or actually making edits to the document and asking students to accept or reject them. If the feedback is very abstract (e.g. switch the order of two clauses) it can be unclear to a young student. If the feedback is in the form of a suggested revision, the student can simply accept the suggestion without thinking and learning about it. These modes of feedback are not as instructionally effective as the more traditional editor's comments on a physical document which the student has to consider as s(he) interprets the comments and makes revisions to their document. The present teachings simulate the more effective traditional approach by virtualizing a snippet of the student's paper and permitting the teacher to draw on the snippet (the virtual note paper) with a finger, a stylus or a mouse, but effectively captures the feedback in digital form facilitating future review.

### Example 2

### Use Case Scenario—Review of Notes on Experiments Taken in a Laboratory Setting

There is a trend in laboratory settings where traditional paper lab books are used to record experimental procedures and observations of adopting digital recording systems that replace the traditional paper ones. These digital systems offer immediate digital storage of entries and backup for security purposes, as well searchability, legibility and other benefits. They are frequently reviewed and commented on by lab managers or researcher supervisors. But for some types of information—photographs or drawings for example—it is often more convenient to draw on the document than to make a marginal note. A good example would be a microscopy image of a molecular structure, where a particular feature is important to note, and where the researcher has included the image but not noticed the important feature. It is much simpler and more direct for the supervisor to draw on the image—perhaps circling the feature—than to describe where it is and what it looks like in a text note. But the supervisor may not have the capability in the digital lab note system to mark directly on an image. If it exists the supervisor may not want to mark directly on the image, potentially obscuring it and diminishing the value of the picture for the research or other readers of the digital lab book. It would be much better for the supervisor to select the image, have it applied to a note that could be positioned preceding or superseding the relevant section of the digital document, and draw (or type textual information) on the copy of the image on the note.

All references set forth herein are expressly incorporated by reference in their entireties for all purposes.

Those skilled in the art can now appreciate from the foregoing description that the broad teachings herein can be implemented in a variety of forms. Therefore, while the present teachings have been described in connection with various embodiments and examples, the scope of the present teachings are not intended, and should not be construed to be, limited thereby. Various changes and modifications can be made without departing from the scope of the present teachings.

It is claimed:

1. A computer-implemented method for annotating digital documents, comprising:
(i) transmitting over a network instructions, executable at a remote computing device, providing functionality for annotating a digital document, including encoding into raster graphics image format a user-selected portion of the digital document;
(ii) receiving from the remote computing device, over the network, a raster graphics image comprising a facsimile of the user-selected portion of the digital document and one or more user annotations;
(iii) associating the annotated image with a location of the user-selected portion within the digital document;
(iv) placing the annotated image in persistent storage;
(v) receiving from the remote computing device, over the network, a request for the stored annotated image; and
(vi) transmitting to the remote computing device over the network, the retrieved annotated image;
whereby, when the user-selected portion of the digital document is displayed at the remote computing device, the retrieved annotated facsimile can be displayed proximate thereto.

2. The method of claim 1, further comprising, assigning a unique identifier to the annotated image.

3. The method of claim 2, further comprising transmitting the identifier over the network to the remote computing device.

4. The method of claim 1, further comprising transmitting instructions for placement of the annotated image within the digital document.

5. A method for annotating a digital document using a network-capable computing device, comprising:
(i) providing a digital document;
(ii) transmitting a request over a network to a server for instructions, executable at the computing device, providing functionality for annotating the digital document, including transcribing into raster graphics image format a selected portion of the digital document;
(iii) receiving the instructions from the server;
(iv) selecting a portion of the digital document for annotation;
(v) transcribing the selected portion of the digital document to a raster graphics image;
(vi) annotating the image; and
(vii) displaying the annotated image proximate the selected portion of the digital document.

6. The method of claim 5, wherein the annotating step is carried out freehand.

7. The method of claim 6, wherein the annotating step is carried out using a touchpad, trackball, mouse, finger or stylus.

8. The method of claim 5, wherein the annotating step includes creating one or more geometric shape annotations.

9. The method of claim 8, wherein the one or more geometric shape annotations are created as bitmapped images, which are superimposed on the raster graphics image.

10. The method of claim 5, wherein the annotating step includes creating one or more styled text annotations.

11. A non-transitory, computer-readable storage medium containing program code for, when executed by a computing system, performing a method for annotating digital documents, said method comprising:
(i) transmitting over a network instructions, executable at a remote computing device, providing functionality for annotating a digital document, including encoding into raster graphics image format a user-selected portion of the digital document;
(ii) receiving from the remote computing device, over the network, a raster graphics image comprising a facsimile of the user-selected portion of the digital document and one or more user annotations;
(iii) associating the annotated image with a location of the user-selected portion within the digital document;
(iv) placing the annotated image in persistent storage;
(v) receiving from the remote computing device, over the network, a request for the stored annotated image; and
(vi) transmitting to the remote computing device over the network, the retrieved annotated image.

12. The method of claim 11, further comprising, assigning a unique identifier to the annotated image.

13. A computing system for annotation of a digital document, comprising:
a network interface for communication over a network;
a memory comprising at least one software program comprising instructions, distributable over the network to one or more remote locations, providing functionality upon execution by a processor for annotating a digital document, including encoding into raster graphics image format one or more user-selected portions of the digital document;
an input for receiving, from the one or more remote locations over the network, a raster graphics image comprising a facsimile of a user-selected portion of a digital document and one or more user annotations;
an output for transmitting to the one or more remote locations over the network (a) the received annotated image, and (b) the instructions;
a persistent storage device for storage and retrieval of the received annotated image; and
an associator component for associating the annotated image with a location of the user-selected portion within the digital document.

14. The system of claim 13, wherein the memory further comprises at least one software program comprising instructions, distributable over the network to the one or more remote locations, providing functionality upon execution by a processor for placement of the annotated image proximate its associated location.

15. The system of claim 13, further comprising an identifier component for assigning a unique code to the received annotated image.

16. A method for annotating a digital document, comprising:
(i) providing a digital document;
(ii) using a processor of a computing device, executing software code providing functionality for annotating the digital document, including transcribing into raster graphics image format a selected portion of the digital document;
(iii) selecting a portion of the digital document for annotation;
(iv) transcribing the selected portion of the digital document to a raster graphics image;
(v) annotating the image; and
(vi) displaying the annotated image proximate the selected portion of the digital document.

17. The method of claim 16, further comprising receiving the software code from at least one server computing system.

18. The method of claim 17, wherein the method is carried out employing a client computing device.

19. The method of claim 16, wherein the digital document comprises an html or xml document.

20. The method of claim 16, further comprising analyzing the document object model elements and attributes related to the selection from step (iii).
